(19) United States
(12) Patent Application Publication
(10) Pub. No.: US 2023/0360613 A1
(43) Pub. Date: Nov. 9, 2023

(54) DRIVING METHOD FOR MINI LED BACKLIGHT MODULE, DRIVING CIRCUIT AND DISPLAY DEVICE

(71) Applicant: TCL CHINA STAR OPTOELECTRONICS TECHNOLOGY CO., LTD., Shenzhen (CN)

(72) Inventors: Zhao Wang, Shenzhen (CN); Jinfeng Liu, Shenzhen (CN)

(73) Assignee: TCL CHINA STAR OPTOELECTRONICS TECHNOLOGY CO., LTD., Shenzhen (CN)

(21) Appl. No.: 17/433,983

(22) PCT Filed: May 31, 2021
(86) PCT No.: PCT/CN2021/097245

§ 371 Date: Aug. 25, 2021

(30) Foreign Application Priority Data
Mar. 17, 2021 (CN) 202110284448.0

(51) Int. Cl. G09G 3/34; G09G 3/32

(52) U.S. Cl. CPC G09G 3/3426; G09G 3/32; G09G 2310/0267; G09G 2310/0275; G09G 2330/06; G09G 2320/0271

(57) ABSTRACT

A mini LED backlight module, a driving circuit and a display device are provided. Emitting units of the same row in the mini LED backlight module are divided into multiple sections that could be illuminated differently. This could avoid the issue of a high backlight current pulse when each row of light emitting units in different backlight sections is simultaneously illuminated and thus alleviate the issue of reducing the lifetime of light emitting units.

### FIELD OF THE DISCLOSURE

The present disclosure relates to a display technology, and more particularly, to a driving method for driving a mini light emitting diode (LED) backlight module, a driving circuit and a display device.

### BACKGROUND

The mini LED technology could be regarded as an upgrade of the liquid crystal display. The mini LED backlight layer could have more LEDs in a unit area and thus the number of backlight units is increased and the regional luminance could be adjusted. That is, a region could be entirely black because the LEDs corresponding to the region could be turned off. This not only reduces the power consumption but also makes the display effect more delicate. This is because a large number of LEDs could achieve a high contrast and delicate dynamic distribution to make the bright region brighter and the dark region darker.

Please refer to FIG. 1. FIG. 1 is a diagram of a conventional mini LED backlight module. The mini LED backlight module is achieved by assembling a plurality of backlight plates (each dotted line block is a backlight plate). Each of the backlight plates have organic LEDs (OLEDs) arranged in an array. Although the backlight plates are independently scanned and driven, these backlight plates are simultaneously illuminated in a frame period. That is, each row of LEDs of the mini LED backlight module works at the same time. This means that each row of LEDs of the mini LED backlight module could be illuminated at the same time and thus the current may have a huge pulse. This may reduce the lifetime of OLEDs and introduces the noise and electromagnetic interferences.

Therefore, a driving method for driving a mini LED backlight module, a driving circuit and a display device are needed to solve the above-mentioned issue of the high current pulse when the mini LED backlight module works.

### SUMMARY

### Technical Problem

The mini LED backlight module is achieved by assembling a plurality of backlight plates (each dotted line block is a backlight plate). Each of the backlight plates have organic LEDs (OLEDs) arranged in an array. Although the backlight plates are independently scanned and driven, these backlight plates are simultaneously illuminated in a frame period. That is, each row of LEDs of the mini LED backlight module works at the same time. This means that each row of LEDs of the mini LED backlight module could be illuminated at the same time and thus the current may have a huge pulse. This may reduce the lifetime of OLEDs and introduces the noise and electromagnetic interferences.

### Technical Solution

One objective of an embodiment of the present disclosure is to provide a mini LED backlight module, a driving circuit and a display device, to solve the above-mentioned issue of the high current pulse when the mini LED backlight module works.

According to an embodiment of the present disclosure, a driving method for driving a mini light emitting diode (LED) backlight module is disclosed. The mini LED backlight module comprises k horizontally-arranged backlight sections. Each of the backlight sections comprises light emitting units arranged in an m*n array, wherein m, n and k are integers. The driving method comprises: providing m scan signals according to a predetermined timing and sequentially scanning m rows of the light emitting units of the mini LED backlight modules according to the scan signals during each frame time; and when an i^{th} row of the mini LED backlight module is being scanned, sequentially inputting a data signal to a first to a k^{th} backlight sections according to luminance information to respectively drive the i^{th} row of the first to the k^{th} backlight sections such that all the light emitting units in the mini LED backlight work together at the same time during each frame time; wherein i is an integer and 1≤i≤m.

In some embodiments, the step of sequentially inputting data signals to a first to a k^{th} backlight sections to respectively drive the i^{th} row of the first to the k^{th} backlight sections comprises:
inputting the data signal to the first backlight section to drive n light emitting diodes of the i^{th} row of the first backlight section to work;
inputting the data signal to the second backlight section to drive n light emitting diodes of the i^{th} row of the second backlight section to work;
and until inputting the data signal to the k^{th} backlight section to drive n light emitting diodes of the i^{th} row of the k^{th} backlight section to work.

In some embodiments, there is a unit time interval between successively driving the i^{th} row of the light emitting units of two backlight sections, and the unit time interval is a time period for illuminating a row of the light emitting units of each backlight section.

In some embodiments, the step of all the light emitting units in the mini LED backlight work together at the same time comprises:
determining backlight grayscale information according to the luminance information and controlling a time period for illuminating each row of the light emitting units of each backlight section such that a backlight source provided by the mini LED backlight module reaches a backlight grayscale required by the backlight grayscale information.

In some embodiments, each backlight section has an identical area and an identical shape.

According to an embodiment of the present disclosure, a driving circuit for driving a mini LED backlight module is disclosed. The mini LED backlight module comprises k horizontally-arranged backlight sections. Each of the backlight sections comprises light emitting units arranged in an m*n array, where m, n and k are integers. The driving circuit comprises: a gate driver, configured to provide m scan signals according to a predetermined timing and sequentially scan m rows of the light emitting units of the mini LED backlight modules according to the scan signals during each frame time; and a source driver, configured to, when an i^{th} row of the mini LED backlight module is being scanned, sequentially input a data signal to a first to a k^{th} backlight sections according to luminance information to respectively drive the i^{th} row of the first to the k^{th} backlight sections such that all the light emitting units in the mini LED backlight work together at the same time during each frame time; wherein i is an integer and 1≤i≤m.

In some embodiments, each of the backlight section has an identical area and an identical shape.

In some embodiments, each of the backlight plates has an identical area and an identical shape.

In some embodiments, each of the backlight plates has an identical number of the light emitting units.

In some embodiments, the source driver is further configured to determine backlight grayscale information according to the luminance information and control a time period for illuminating each row of the light emitting units of each backlight section such that a backlight source provided by the mini LED backlight module reaches a backlight grayscale required by the backlight grayscale information.

In some embodiments, each of the backlight sections comprises a plurality of horizontally and/or vertically arranged backlight plates, each of the backlight plates comprises a driving unit and the plurality of light emitting units, the driving unit is connected respectively to the light emitting units and the source driver, and the source driver controls a time period for illuminating the light emitting units and a luminance of the light emitting units through the driving unit.

In some embodiments, the light emitting units are organic LEDs.

According to an embodiment of the present disclosure, a display device is disclosed. The display device comprises a mini LED backlight module and a driving circuit. The driving circuit is configured to drive the mini LED backlight module to provide backlight to the display device. According to an embodiment of the present disclosure, a driving method for driving a mini light emitting diode (LED) backlight module is disclosed. The mini LED backlight module comprises k horizontally-arranged backlight sections. Each of the backlight sections comprises light emitting units arranged in an m*n array, wherein m, n and k are integers. The driving method comprises: providing m scan signals according to a predetermined timing and sequentially scanning m rows of the light emitting units of the mini LED backlight modules according to the scan signals during each frame time; and when an i^{th} row of the mini LED backlight module is being scanned, sequentially inputting a data signal to a first to a k^{th} backlight sections according to luminance information to respectively drive the i^{th} row of the first to the k^{th} backlight sections such that all the light emitting units in the mini LED backlight work together at the same time during each frame time; wherein i is an integer and 1≤i≤m. The source driver is further configured to determine backlight grayscale information according to the luminance information and control a time period for illuminating each row of the light emitting units of each backlight section such that a backlight source provided by the mini LED backlight module reaches a backlight grayscale required by the backlight grayscale information.

In some embodiments, each of the backlight sections comprises a plurality of horizontally and/or vertically arranged backlight plates, each of the backlight plates comprises a driving unit and the plurality of light emitting units, the driving unit is connected respectively to the light emitting units and the source driver, and the source driver controls a time period for illuminating the light emitting units and a luminance of the light emitting units through the driving unit.

In some embodiments, the light emitting units are organic LEDs.

In some embodiments, each of the backlight section has an identical area and an identical shape.

In some embodiments, each of the backlight plates has an identical area and an identical shape.

In some embodiments, each of the backlight plates has an identical number of the light emitting units.

According to an embodiment, a mini LED backlight module, a driving circuit and a display device are disclosed. The mini LED backlight module comprises k horizontally-arranged backlight sections. The driving circuit comprises a gate driver and a source driver. During each frame time, when the gate driver provides a scan signal to provide a working power to a row of light emitting units in the mini LED backlight module, the source driver orderly drive the row of light emitting units of each of the horizontally-assembled backlight sections to work together at the same time according to the luminance information. That is, the source driver could respectively illuminate or does not illuminate the row of light emitting units of multiple backlight sections at the same time. Accordingly, the emitting units of the same row in the conventional mini LED backlight module are divided into multiple sections that could be illuminated differently. This could avoid the issue of a high backlight current pulse when each row of light emitting units in different backlight sections is simultaneously illuminated and thus alleviate the issue of reducing the lifetime of light emitting units and the noise and electromagnetic interferences.

### BRIEF DESCRIPTION OF THE DRAWINGS

FIG. 1 is a diagram of a conventional mini LED backlight module.

FIG. 2 is a timing diagram of data signals in a conventional mini LED backlight module.

FIG. 3 is a diagram of a mini LED backlight module according to an embodiment of the present disclosure.

FIG. 4 is a timing diagram of a first data signal in a mini LED backlight module according to an embodiment of the present disclosure.

FIG. 5 is a diagram of a mini LED backlight module according to another embodiment of the present disclosure.

FIG. 6 is a timing diagram of a second data signal in a mini LED backlight module according to an embodiment of the present disclosure.

FIG. 7 is a flow chart of a driving method for driving a mini LED backlight module according to an embodiment of the present disclosure.

### DETAILED DESCRIPTION

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure.

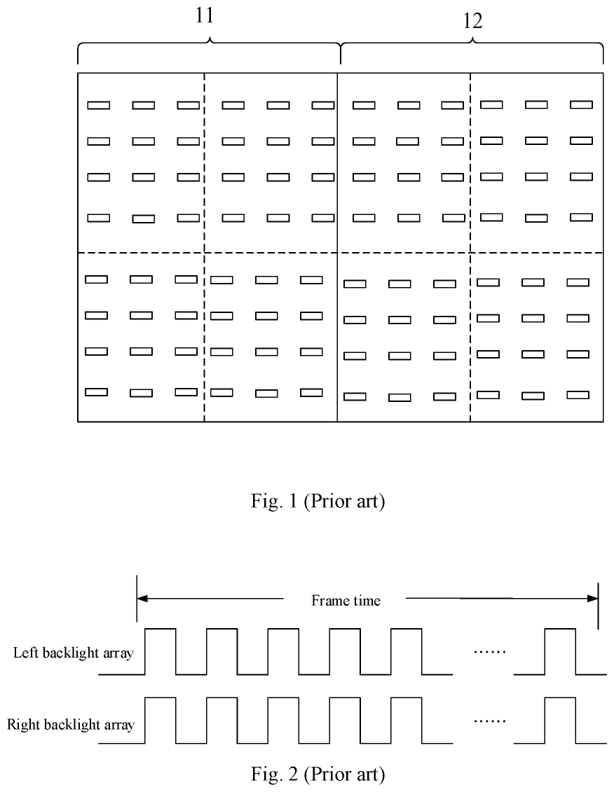

As shown in FIG. 1, take the mini LED backlight module having a left backlight section 11 and a right backlight section 12 as an example. In a frame time, the left backlight section 11 and the right backlight section 12 are illuminated at the same time. That is, the same row of the LEDs of the left backlight section 11 and the right backlight section 12 works at the same time. Please refer to FIG. 2. FIG. 2 is a timing diagram of data signals in a conventional mini LED backlight module. As shown in FIG. 2, when a scan signal is inputted into the same row of the LEDs in the left backlight section 11 and the right backlight section 12, the data signal is simultaneously inputted to the left backlight section 11 and the right backlight section 12 such that the same row of LEDs of the left backlight section 11 and the right backlight section 12 is turned on at the same time. In this way, every time when a row of LEDs in the mini LED backlight module needs to be illuminated, the backlight current may have a higher pulse. In addition, when the data signal is simultaneously inputted into the left backlight section 11 and the right backlight section 12, the backlight current is switched between a high current value and a low current value (this means that the backlight current generates a higher pulse). This will cause a larger damage on the LEDs of the mini LED backlight module, reduce the lifetime of the LEDs and introduce the issues of noises and electromagnetic interferences.

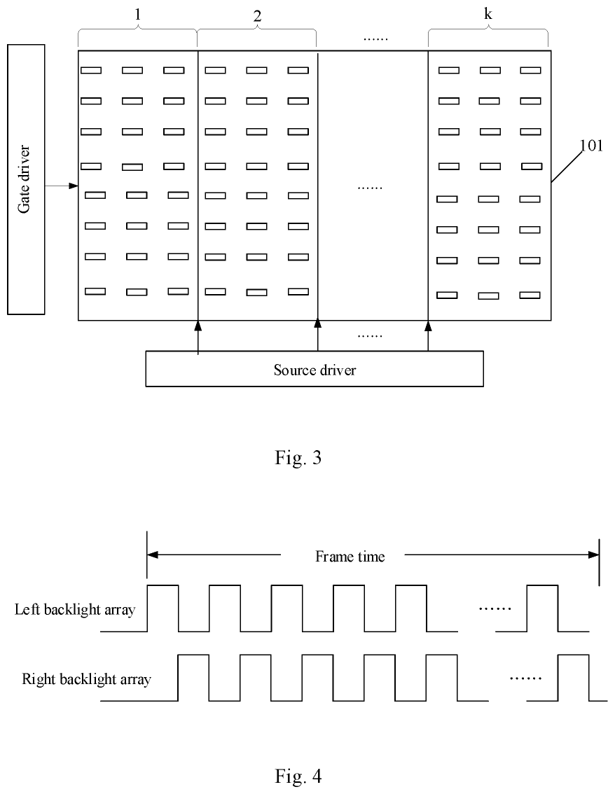

According to an embodiment, a driving circuit for driving a mini LED backlight module is disclose to deal with the above issues. Please refer to FIG. 3. FIG. 3 is a diagram of a mini LED backlight module according to an embodiment of the present disclosure. As shown in FIG. 3, the mini LED backlight module comprises k horizontally-assembled backlight sections 101. Each of the backlight sections 101 comprises m*n light emitting units (m rows and n columns) Here, m, n and k are all integers. The driving circuit comprises a gate driver and a source driver.

The gate driver is configured to provide m scan signals according to a predetermined timing and sequentially scan m rows of the light emitting units of the mini LED backlight modules according to the scan signals during each frame time.

The source driver is configured to, when an i^{th} row of the mini LED backlight module is being scanned, sequentially input a data signal to a first to a k^{th} backlight sections according to luminance information to respectively drive the i^{th} row of the first to the k^{th} backlight sections such that all the light emitting units in the mini LED backlight work together at the same time during each frame time.

During each frame time, the gate driver first provides m scan signals according to the predetermined timing to drive m rows of light emitting units in the mini LED backlight modules. That is, the gate driver sequentially scans a row corresponding to each scan signal. For example, when the i^{th} scan signal drives the i^{th} row of light emitting units, the source driver sequentially inputs a data signal to the first to the k^{th} backlight sections 101 according to luminance information to respectively drive the i^{th} row of the first to the k^{th} backlight sections 101 such that all the light emitting units in the mini LED backlight work together at the same time during each frame time. Here, “n light emitting units work together at the same time” means that the n light emitting units are illuminated or not illuminated at the same time. The luminance information comprise the information showing whether the m rows of light emitting units in each of the backlight sections 101 needs to be illuminated or not illuminated.

In the driving circuit of the mini LED backlight module, when the gate driver provides the power to a certain row of the mini LED backlight module, the source driver respectively inputs the data signal to the first to the k^{th} backlight sections to orderly drive the certain row of the first to the k^{th} backlight sections 101 to make them work together at the same time. Therefore, in contrast to the conventional mini LED backlight module, which simultaneously drive all rows of the mini LED backlight module, the driving circuit of the present disclosure could reduce the current amplitude and the high current pulse and thus avoid the issues of the high backlight current because the same row of light emitting units in the mini LED backlight module is illuminated.

The driving circuit of the mini LED backlight module follows the ordinary timing of the scan signal outputted by the gate driver but modifies the timing of the data signal outputted by the source driver. In other words, the driving circuit could only modify the timing of the data signal without affecting the timing of the scan signal. This could simplify the working process of the driving circuit of the mini LED backlight module.

For example, take k=2, which means that the mini LED backlight module has two backlight modules 101 (the left backlight section 11 and the right backlight section 12 shown in FIG. 1), as an example. Please refer to FIG. 4. FIG. 4 is a timing diagram of a first data signal in a mini LED backlight module according to an embodiment of the present disclosure. As shown in FIG. 1 and FIG. 4, assume that it needs a first unit time period for illuminating a row of the left backlight section 11 and the right backlight section 12. The driving circuit drives the same row of the left backlight section 11 and the right backlight section 12 in an interleaving way to illuminate the same row of light emitting units to work at the same time. That is, when the gate driver provides the power to the i^{th} row of the light emitting units, the source driver firstly inputs the data signal to the left backlight section 11 and then inputs the data signal to the right backlight section 12. In other words, the difference between the timings for inputting the data signal into the left backlight section 11 and the right backlight section 12 is one first unit time period. Please note, in FIG. 4, we take an example where all the light emitting units in the mini LED backlight module are illuminated (that is, the data signal inputted into the left backlight section 11 and the right backlight section 12 is a high voltage level signal.)

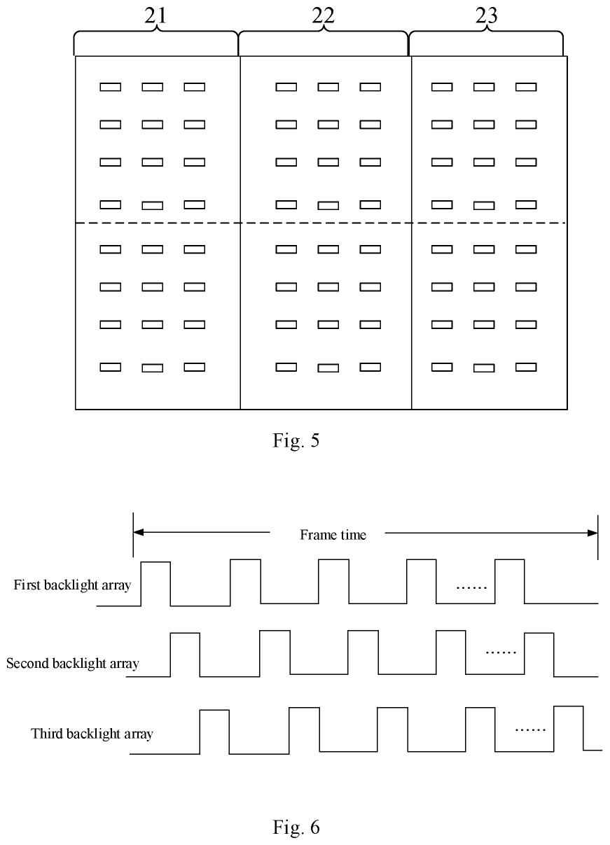

Please refer to FIG. 5 in conjunction with FIG. 6. FIG. 5 is a diagram of a mini LED backlight module according to another embodiment of the present disclosure. FIG. 6 is a timing diagram of a second data signal in a mini LED backlight module according to an embodiment of the present disclosure. As shown in FIG. 5, take k=3 (this means that the mini LED backlight module comprises three backlight sections, the left backlight section (the first backlight section) 21, the middle backlight section (the second backlight section) 22 and the right backlight section (the third backlight section) 23 as an example. Assume it needs a second unit time period to illuminate a row of the first backlight section 21, the second backlight section 22 and the third backlight section 23. Here, the same row of the light emitting units of the first backlight section 21, the second backlight section 22 and the third backlight section 23 is orderly driven to work together at the same time. That is, when the gate driver provides the power to the i^{th} row of the light emitting units, the source driver firstly inputs the data signal to the first backlight section 21, then inputs the data signal to the second backlight section 22, and at last inputs the data signal to the third backlight section 23. In other words, the timing between inputting the data signal into the first backlight section 21, the second backlight section 22 and the third backlight section 23 is one second unit period time. Please note, in FIG. 6, we take an example where all the light emitting units in the mini LED backlight module are illuminated (that is, the data signal inputted into the first backlight section 21, the second backlight section 22 and the third backlight section 23 is a high voltage level signal.)

In order to drive all the light emitting units in the mini LED backlight module in a frame time, normally, the mini LED backlight module is not divided into too many backlight sections. Otherwise, as shown in FIG. 4 and FIG. 6, the number of the impulses of the data signal might not be enough for illuminate all the emitting units in each of the backlight sections 101. Therefore, normally, k is not greater than 10. That is, the mini LED backlight module is not divided into more than 10 horizontally-assembled backlight sections 101.

In this embodiment, the driving module of the mini LED backlight module could reduce the amplitude and pulses of the backlight current.

The reason why the data signal is respectively inputted into the first to the k^{th} backlight sections 101 is to reduce the amplitude and pulses of the backlight current when a certain row of light emitting units in the mini LED backlight module is illuminated. For a certain backlight section 101, if a certain row of the light emitting units does not need to be illuminated, then the data signal inputted to the certain backlight section corresponds to the low voltage level. At this time, the backlight current is comparatively low. Therefore, the driving circuit of the mini LED backlight module could reduce the amplitude of the overall backlight current.

Based on the gamma curve, the backlight gamma information could be determined according to the luminance information. Therefore, in the driving circuit of the mini LED backlight module, the source driver is further configured to determine backlight grayscale information according to the luminance information and control a time period for illuminating each row of the light emitting units of each backlight section such that a backlight source provided by the mini LED backlight module reaches a backlight grayscale required by the backlight grayscale information.

Each of the backlight section 101 has an identical area and an identical shape.

Each of the backlight section 101 comprises a plurality of horizontally assembled and/or vertically assembled backlight plates. As shown in FIG. 1, each backlight section 101 is assembled by four backlight plates (each dotted block represents one backlight plate). Here, two backlight plates are horizontally assembled. And two sets of two horizontally-assembled backlight plates are vertically assembled to form a backlight section 101. As shown in FIG. 5, each backlight section 101 is formed by vertically assembling two backlight plates (each dotted block represents a backlight plate).

In addition, each of the backlight plates has a driving unit (not shown) and a plurality of light emitting units. Here, the driving unit of each of the backlight plates is respectively connected to the light emitting units and the source driver. The source driver controls the illuminating time period for illuminating the light emitting units and the luminance of the light emitting units through the driving unit.

In this embodiment, the light emitting units are OLEDs.

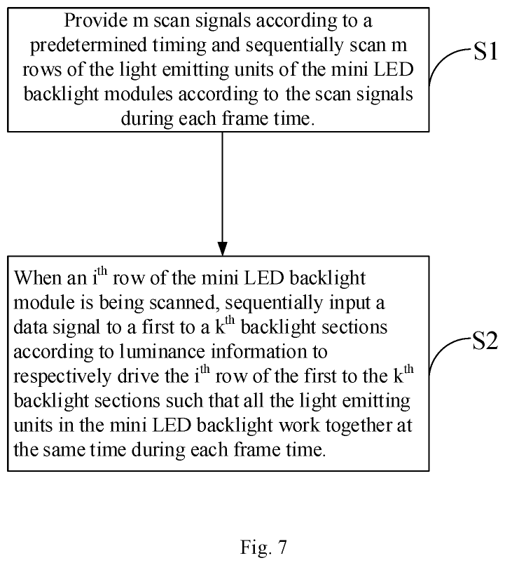

Please refer to FIG. 7. FIG. 7 is a flow chart of a driving method for driving a mini LED backlight module according to an embodiment of the present disclosure. As shown in FIG. 7, a driving method for driving a mini LED backlight module is disclosed. The driving method is adopted in the above-mentioned driving circuit of the mini LED driving circuit. The driving circuit comprises a gate driver, a source driver and k horizontally-assembled backlight sections. Each backlight section comprises m*n light emitting units (m rows and n columns). Here, m, n and k are all integers. The driving method comprises:
S1: providing m scan signals according to a predetermined timing and sequentially scanning m rows of the light emitting units of the mini LED backlight modules according to the scan signals during each frame time.
S2: when an i^{th} row of the mini LED backlight module is being scanned, sequentially inputting a data signal to a first to a k^{th} backlight sections according to luminance information to respectively drive the i^{th} row of the first to the k^{th} backlight sections such that all the light emitting units in the mini LED backlight work together at the same time during each frame time. Here, i is an integer and 1≤i≤m.

Based on the above-mentioned embodiments, the step of sequentially inputting data signals to a first to a k^{th} backlight sections to respectively drive the i^{th} row of the first to the k^{th} backlight sections in step S2 comprises: inputting the data signal to the first backlight section to drive n light emitting diodes of the i^{th} row of the first backlight section to work; inputting the data signal to the second backlight section to drive n light emitting diodes of the i^{th} row of the second backlight section to work; and so on until inputting the data signal to the k^{th} backlight section to drive n light emitting diodes of the i^{th} row of the k^{th} backlight section to work.

In other words, when a certain row of light emitting units in the mini LED backlight module is being scanned, the data signal is orderly inputted into the k backlight sections 101 such that the certain row of n light emitting units of the first backlight section 101 is simultaneously illuminated, then the certain row of n light emitting units of the second backlight section 101 is simultaneously illuminated . . . and so on, until the certain row of n light emitting units of the k^{th} backlight section 101 is simultaneously illuminated. In this way, all the emitting units in the mini LED backlight module are illuminated.

Based on the above-mentioned embodiments, the step of all the light emitting units in the mini LED backlight work together at the same time in step S2 comprises: determining backlight grayscale information according to the luminance information and controlling a time period for illuminating each row of the light emitting units of each backlight section such that a backlight source provided by the mini LED backlight module reaches a backlight grayscale required by the backlight grayscale information.

Furthermore, based on the same inventive concept, a display device is disclosed according to an embodiment of the present disclosure. The display device comprises a mini LED backlight module and the above-mentioned driving circuit. Here, the driving circuit is configured to drive the mini LED backlight module to provide a backlight source to the display device. The driving circuit of the display device has a similar structure and advantage of that of the mini LED backlight module. Because the structure and the operations of the driving circuit has been illustrated in the disclosure above, further illustration is omitted here.

According to an embodiment, a mini LED backlight module, a driving circuit and a display device are disclosed. The mini LED backlight module comprises k horizontally-arranged backlight sections. The driving circuit comprises a gate driver and a source driver. During each frame time, when the gate driver provides a scan signal to provide a working power to a row of light emitting units in the mini LED backlight module, the source driver orderly drive the row of light emitting units of each of the horizontally-assembled backlight sections 10 to work together at the same time according to the luminance information. That is, the source driver could respectively illuminate or does not illuminate the row of light emitting units of multiple backlight sections 101 at the same time. Accordingly, the emitting units of the same row in the conventional mini LED backlight module are divided into multiple sections that could be illuminated differently. This could avoid the issue of a high backlight current pulse when each row of light emitting units in different backlight sections is simultaneously illuminated and thus alleviate the issue of reducing the lifetime of light emitting units and the noise and electromagnetic interferences.

Above are embodiments of the present disclosure, which does not limit the scope of the present disclosure. Any modifications, equivalent replacements or improvements within the spirit and principles of the embodiment described above should be covered by the protected scope of the disclosure.

What is claimed is:

1. A driving method for driving a mini light emitting diode (LED) backlight module, the mini LED backlight module comprising k horizontally-arranged backlight sections, each of the backlight sections comprising light emitting units arranged in an m*n array, wherein m, n and k are integers; and the driving method comprising:
providing m scan signals according to a predetermined timing and sequentially scanning m rows of the light emitting units of the mini LED backlight modules according to the scan signals during each frame time; and
when an i^{th} row of the mini LED backlight module is being scanned, sequentially inputting a data signal to a first to a k^{th} backlight sections according to luminance information to respectively drive the i^{th} row of the first to the k^{th} backlight sections such that all the light emitting units in the mini LED backlight work together at the same time during each frame time;
wherein i is an integer and 1≤i≤m.

2. The driving method of claim 1, wherein the step of sequentially inputting data signals to a first to a k^{th} backlight sections to respectively drive the i^{th} row of the first to the k^{th} backlight sections comprises:
inputting the data signal to the first backlight section to drive n light emitting diodes of the i^{th} row of the first backlight section to work;
inputting the data signal to the second backlight section to drive n light emitting diodes of the i^{th} row of the second backlight section to work;
and until inputting the data signal to the k^{th} backlight section to drive n light emitting diodes of the i^{th} row of the k^{th} backlight section to work.

3. The driving method of claim 1, wherein there is a unit time interval between successively driving the i^{th} row of the light emitting units of two backlight sections, and the unit time interval is a time period for illuminating a row of the light emitting units of each backlight section.

4. The driving method of claim 1, wherein the step of all the light emitting units in the mini LED backlight work together at the same time comprises:
determining backlight grayscale information according to the luminance information and controlling a time period for illuminating each row of the light emitting units of each backlight section such that a backlight source provided by the mini LED backlight module reaches a backlight grayscale required by the backlight grayscale information.

5. The driving method of claim 1, wherein each backlight section has an identical area and an identical shape.

6. A driving circuit for driving a mini LED backlight module, the mini LED backlight module comprising k horizontally-arranged backlight sections, each of the backlight sections comprising light emitting units arranged in an m*n array, wherein m, n and k are integers; and the driving circuit comprising:
a gate driver, configured to provide m scan signals according to a predetermined timing and sequentially scan m rows of the light emitting units of the mini LED backlight modules according to the scan signals during each frame time; and
a source driver, configured to, when an i^{th} row of the mini LED backlight module is being scanned, sequentially input a data signal to a first to a k^{th} backlight sections according to luminance information to respectively drive the i^{th} row of the first to the k^{th} backlight sections such that all the light emitting units in the mini LED backlight work together at the same time during each frame time;
wherein i is an integer and 1≤i≤m.

7. The driving circuit of claim 6, wherein the source driver is further configured to determine backlight grayscale information according to the luminance information and control a time period for illuminating each row of the light emitting units of each backlight section such that a backlight source provided by the mini LED backlight module reaches a backlight grayscale required by the backlight grayscale information.

8. The driving circuit of claim 6, wherein each of the backlight sections comprises a plurality of horizontally and/or vertically arranged backlight plates, each of the backlight plates comprises a driving unit and the plurality of light emitting units, the driving unit is connected respectively to the light emitting units and the source driver, and the source driver controls a time period for illuminating the light emitting units and a luminance of the light emitting units through the driving unit.

9. The driving circuit of claim 6, wherein the light emitting units are organic LEDs.

10. The driving circuit of claim 6, wherein each of the backlight section has an identical area and an identical shape.

11. The driving circuit of claim 8, wherein each of the backlight plates has an identical area and an identical shape.

12. The driving circuit of claim 8, wherein each of the backlight plates has an identical number of the light emitting units.

13. A display device, comprising:
a mini LED backlight module; and
a driving circuit, configured to drive the mini LED backlight module to provide backlight to the display device, wherein the mini LED backlight module comprises k horizontally-arranged backlight sections, each of the backlight sections comprises light emitting units arranged in an m*n array, where m, n and k are integers; and the driving circuit comprises:
a gate driver, configured to provide m scan signals according to a predetermined timing and sequentially scan m rows of the light emitting units of the mini LED backlight modules according to the scan signals during each frame time; and
a source driver, configured to, when an i^{th} row of the mini LED backlight module is being scanned, sequentially input a data signal to a first to a k^{th} backlight sections according to luminance information to respectively drive the i^{th} row of the first to the k^{th} backlight sections such that all the light emitting units in the mini LED backlight work together at the same time during each frame time, where i is an integer and 1≤i≤m; and
wherein the source driver is further configured to determine backlight grayscale information according to the luminance information and control a time period for illuminating each row of the light emitting units of each backlight section such that a backlight source provided by the mini LED backlight module reaches a backlight grayscale required by the backlight grayscale information.

14. The display device of claim 13, wherein each of the backlight sections comprises a plurality of horizontally and/or vertically arranged backlight plates, each of the backlight plates comprises a driving unit and the plurality of light emitting units, the driving unit is connected respectively to the light emitting units and the source driver, and the source driver controls a time period for illuminating the light emitting units and a luminance of the light emitting units through the driving unit.

15. The display device of claim 13, wherein the light emitting units are organic LEDs.

16. The display device of claim 13, wherein each of the backlight section has an identical area and an identical shape.

17. The display device of claim 14, wherein each of the backlight plates has an identical area and an identical shape.

18. The display device of claim 14, wherein each of the backlight plates has an identical number of the light emitting units.
